(19) United States
(12) Patent Application Publication
(10) Pub. No.: US 2010/0171620 A1
(43) Pub. Date: Jul. 8, 2010

(54) THEFT PROTECTION ELEMENT ARRANGED TO BE ATTACHED TO AN ITEM

(75) Inventors: Klas Stoltz, Saltsjobaden (SE); Bo Gustavson, Stockholm (SE)

Correspondence Address: YOUNG & THOMPSON, 209 Madison Street, Suite 500, Alexandria, VA, 22314, US

(73) Assignee: FARGKLAMMAN AB, Kungens Kurva (SE)

(21) Appl. No.: 12/664,526

(22) PCT Filed: May 5, 2008
(86) PCT No.: PCT/SE2008/050504

§ 371 Date: Dec. 14, 2009

(30) Foreign Application Priority Data
Jun. 15, 2007 (SE) 0701466-5

(51) Int. Cl. G08B 13/14; E05B 73/00

(52) U.S. Cl. 340/572.9; 70/58; 70/57.1

(57) ABSTRACT

A theft-protection element intended to be attached to an item that is to be protected from theft and that is of textile or equivalent material, which theft-protection element is arranged to be attached to the item through a needle penetrating and passing through the item. The invention is characterized in that the point (5) of the needle is withdrawn in the resting condition (3a) of the needle into the disc (1) at a first side (7) of the recess (6), in that the point (5) of the needle is located in the said locked condition (3b) at a second, opposing, side (8) of the recess (6), and in that the said recess is sufficiently large that the material of the item can be introduced into it such that the needle (3) can pass through the material of the item, and in that the disc (1) is arranged such that the point (5) of the needle (3) is housed at the said second side (8) of the recess (6) in the locked condition (3b), or is placed in contact with, or is in the vicinity of, the said second side.

The present invention relates to a theft-protection element intended to be attached to an item.

To be more precise, the invention concerns a theft-protection element arranged to be attached to an item that is to be protected from theft and that is of textile or equivalent material. The theft-protection element is arranged to be attached to the item through a needle penetrating and passing through the item.

A number of designs of such theft-protection elements are known. A very common theft-protection element consists of two parts: one part comprising a plate with a protruding needle and one part comprising an arrangement into which the needle can be inserted into a hole, whereby the needle is locked into the arrangement. The theft-protection element is attached through the needle being passed through the item from one of its sides and thereafter being introduced into the hole of the arrangement on the other side of the item. The theft-protection element may be equipped with a dye-filled capsule or with an electronic circuit that interacts with detectors located at the exit from a sales location. The theft-protection element is opened under the influence of a magnet that influences a lock within the said arrangement.

One great disadvantage of this theft-protection element is that it adds a great deal to the thickness, due to the said lock. A typical thickness is greater than 25 millimetres. This causes problems when the same item is to be packed into, for example, a box, and where the theft-protection element is located at the same location on each item. A further great disadvantage is that the theft-protection element consists of two parts. This means that the two parts must be separated from each other when the theft-protection element is removed from an item, and transported in separate containers to a location at which the theft-protection element is once again to be attached to an item. Further, the fact that the person who is to attach the element to an item must place two hands on different sides of the item entails an extra operation.

The present invention solves these problems.

The present invention thus relates to a theft-protection element intended to be attached to an item that is to be protected from theft and that is of textile or equivalent material, which theft-protection element is arranged to be attached to the item through a needle penetrating and passing through the item, where the theft-protection element is a body, such as a disc, comprising an attachment arrangement comprising a needle, which needle is arranged within the body and can be displaced along its longitudinal direction from a resting condition to a locked condition, where the needle has a point at its free end, where the said disc demonstrates a recess located such that the needle in its locked condition bridges the recess, where the point of the needle is withdrawn in the resting condition of the needle into the disc at a first side of the recess, where the point of the needle is located in the locked condition at a second, opposing, side of the recess and where the said recess is sufficiently large that the material of the item can be introduced into it such that the needle can pass through the material of the item, and it is characterized in that the point of the needle is withdrawn in the resting condition of the needle into the disc at a first side of the recess, in that the point of the needle is located in the said locked condition at a second, opposing, side of the recess, and in that the said recess is sufficiently large that the material of the item can be introduced into it such that the needle can pass through the material of the item, and in that the disc is arranged such that the point of the needle in the locked condition is housed within the said second side of the recess or is placed in contact with, or is in the vicinity of, the said second side.

The invention is described in more detail below, partially in association with an embodiment of the invention shown in the attached drawing, where

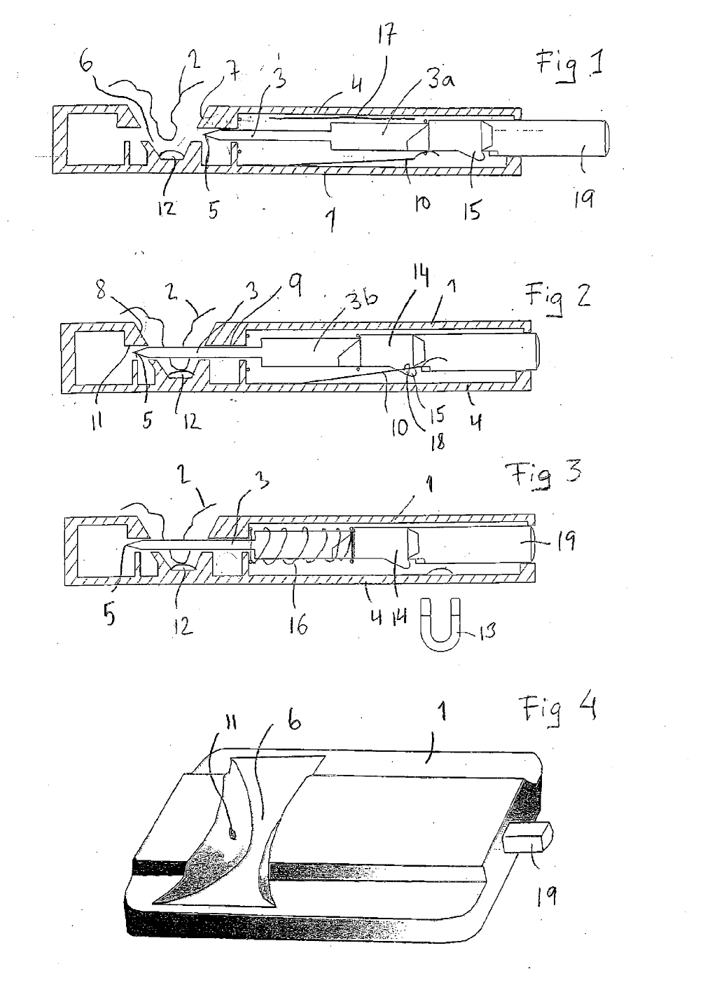

FIG. 1 shows the theft-protection element in cross-section along its longitudinal direction in a first, open condition

FIG. 2 shows the theft-protection element in cross-section along its longitudinal direction in a second, locked condition

FIG. 3 illustrates the operation of a release means

FIG. 4 shows a perspective view of the theft-protection element.

The present theft-protection element is shown in cross-section in FIG. 1. The theft-protection element 1 is intended to be attached to an item that is to be protected from theft and that is of textile or corresponding material. The theft-protection element 1 is arranged to be attached to the item 2, which is partially illustrated in FIG. 1, through a needle 3 penetrating and passing through the item 2, as is illustrated in FIG. 3.

According to the invention, the theft-protection element 1 is a body 4, such as a disc, comprising an attachment arrangement comprising a needle 3, which needle is arranged within the body 4 and can be displaced in its longitudinal direction from a resting condition 3a to a locked condition 3b.

The point 5 of the needle is the free end of the needle. The said disc 1 demonstrates a recess 6 located such that the needle bridges the recess 6 when in its locked condition 3b.

The term “recess” here is used to denote a space having the form of a channel so that it is possible for the needle to bridge in its locked condition and where there is space for a portion of the item to be placed such that the needle penetrates the item in its locked condition. A recess according to the present application can be formed as an indentation in a body or alternatively it may be formed by two protruding members forming between them a space that is a recess relative to the protrusions.

The theft-protection element comprises a slide 14 to which the needle 3 is attached at that end of the needle that is opposite to the pointed end 5 of the needle. The slide 14 is arranged such that it can be displaced within the body and it protrudes a distance out from the body 4 when the needle 3 is located in its resting condition 3a. The said slide 14 is essentially fully contained within the body 1 when the needle 3 is in its locked condition 3b. Furthermore, the slide is arranged such that it can interact with a lock and release means 19.

The point 5 of the needle is withdrawn into the body 1 at a first side 7 of the recess 6 when the needle is in its resting condition 3a. The point of the needle is located in at a second, opposite, side 8 of the recess 6 in the said locked condition 3b. Furthermore, the said recess 6 is sufficiently large such that the material of the item 2 can be introduced into it such that the needle 5 can penetrate the material of the item. Furthermore, it is preferable that the disc is arranged such that the point 5 of the needle 3 in the locked condition is housed at the said second side 8 of the recess 6. Alternatively, the point of the needle may be in contact with, or in the vicinity of, the said second side. What is important is that it is not possible to remove from the disc when the needle is in its locked condition an item that has been penetrated by the needle.

According to one preferred embodiment, the said needle 3 can be displaced in its longitudinal direction along a first channel 9 on one side of the said recess, from the said resting condition 3a to the said locked condition 3b, through a person pressing on the button 19. The needle 3 can be displaced in the opposite direction from the locked condition 3b to the resting condition 3a under the influence of a release means 10.

It is preferable that the needle 3 be displaced in its entirety into the said first channel 9 when it is in its resting condition.

It is furthermore preferable that a channel 11 is present on the second side of the recess 6 in the disc relative to the said first channel 9, which channel extends into the body from the said second side 8 of the recess, in which channel it is arranged that the front end 5 of the needle 3 is present in the said locked condition 3b. It is appropriate that the body of the theft-protection element is made from a plastic material, while it is appropriate that the needle is made from a steel material.

According to one highly preferred embodiment, the theft-protection element comprises a dye ampoule 12 associated with the needle 3, where the theft-protection element 1 is arranged in such a manner that the dye ampoule 12 is arranged to burst in the event of an attempt to bend the needle 3 away from its locked condition 3b. The dye ampoule 12 may be, for example, placed directly under the needle, as is illustrated in the drawings. The dye ampoule may be placed at another location in the theft-protection element 1, the only requirement is that the ampoule 12 is arranged to burst when the needle is bent away from its locked condition 3b.

An alternative is to construct the dye ampoule such that it does not burst. The dye ampoule in this case has a solely deterrent effect.

The theft-protection element is essentially rectangular with a maximum thickness of 15 millimetres.

It is most highly preferred that the theft-protection element 1 is constructed as a single unit, i.e. that only one single unit is to be managed when the element is attached to an item 2 or when it is to be removed from an item 2.

A lock and release means 10 was mentioned above. The release means 10 is a mechanical barrier arranged to be displaced under the influence of a magnet 13 such that the needle 3 can be freely moved from the locked condition 3b to the resting condition 3a.

The lock and release means is so designed that the needle 3, at the end of the needle that is opposite to the point 5 of the needle 3, is attached to a body 14 that preferably has a rectangular cross-section, which body is provided with a locking peg 15 that is arranged to interact with a hole, located at the reference number 18 in FIG. 2, in a leaf spring 10 in the locked condition 3b of the needle 3, see FIG. 2. Thus the needle in FIG. 2 cannot be displaced to the right of the drawing.

The said leaf spring is arranged to be released from the said locking peg under the influence of the said magnet 13 through the leaf spring being displaced downwards in FIG. 3. The needle can thus be displaced to the right of the drawing. A simple pressure spring 16 is arranged to displace the needle 3 from its locked condition 3b to the resting condition 3a. The pressure spring 16 is shown only in FIG. 3.

According to one preferred design, the theft-protection element 1 comprises an electronic element 17 arranged to interact with a detector associated with the exit from a sales location for the item, where the said electronic element is arranged to be activated when the theft-protection element passes through the said exit and in that the said detector is arranged to raise an alarm. Such an electronic element 17 is of a suitable known type and of a type that is commercially available.

A number of embodiments have been described above. The detailed design of the release means may, of course, be changed within the framework of the opportunities open to one skilled in the arts. Furthermore, the recess 6 may be designed such that the recess penetrates partially through the theft-protection element, for example, such that the recess penetrates from one side of the element such that a bridge is formed solely at the second side of the element in order to keep the element united as a unit. Furthermore, the complete theft-protection element may have the form of a bow.

Thus, the present invention can be varied. The present invention is thus not to be considered to be limited to the embodiments described above, since it can be varied within the scope defined by the attached patent claims.

1-11. (canceled)

12. A theft-protection element intended to be attached to an item that is to be protected from theft and that is of textile or equivalent material, which theft-protection element is arranged to be attached to the item through a needle penetrating and passing through the item, where the theft-protection element (1) is a body, such as a disc, comprising an attachment arrangement comprising a straight needle (3), which needle is arranged within the body (1) and can be displaced along its longitudinal direction from a resting condition (3a) to a locked condition (3b), where the needle (3) has a point (5) at its free end, where the said disc demonstrates a recess (6) located such that the needle in its locked condition (3b) bridges the recess (6), characterized in that the point (5) of the needle is withdrawn in the resting condition (3a) of the needle into the disc (1) at a first side (7) of the recess (6), where the point (5) of the needle is located in said locked condition (3b) at a second, opposing, side (8) of the recess (6), in that the said recess is sufficiently large that the material of the item can be introduced into it such that the needle (3) can pass through the material of the item, in that the point (5) of the needle in the said locked condition (3b) is penetrating into said second side (8) of the recess (6), and in that the end of the needle, which is opposite to the point end (5) of the needle, is fastened at a slide (14) which is located inside said disc (1) and inside of said recess (6) both in said locked condition and resting condition of the needle.

13. A theft-protection element according to claim 12, characterized in that said slide (14) is arranged to be displaced within the body, in that the said slide (14) protrudes a certain distance out from the body (1) when the needle (3) is in its resting condition (3a) and in that the said slide (14) is essentially fully depressed within the body (1) when the needle (3) is in its locked condition (3b), and in that the slide is arranged to interact with a lock and release means (19).

14. A theft-protection element according to claim 12, characterized in that the said needle (3) can be displaced in its longitudinal direction along a first channel (9), on one side of the said recess (6), from the said resting condition (3a) to the said locked condition (3b) and in that the needle can be displaced in the opposite direction from the locked condition to the resting condition after the influence of a release means (10).

15. A theft-protection element according to claim 12, characterized in that the needle (3) can be displaced in its resting position (3a) in its entirety into the said first channel (9).

16. A theft-protection element according to claim 14, characterized in that a channel (11) is present on the second side of the recess (6) in the disc relative to the said first channel (9), which channel extends into the body from the said second side (8) of the recess, in which channel it is arranged that the front end (5) of the needle (3) is present in the said locked condition (3b).

17. A theft-protection element according to claim 12, characterized in that the theft-protection element comprises a dye ampoule (12) associated with the needle (3) and in that the element (1) is arranged such that the dye ampoule is arranged to split in the event of an attempt to bend the needle (3) away from its locked condition (3b).

18. A theft-protection element according to claim 12, characterized in that the element (1) is essentially rectangular with a maximum thickness of 15 millimetres.

19. A theft-protection element according to claim 12, characterized in that the element (1) is designed as a unit.

20. A theft-protection element according to claim 12, characterized in that the release means (10) is a mechanical barrier arranged such that it is displaced under the influence of a magnet (13) such that the slide and thus also the needle (3) can freely be moved from the locked condition (3b) to the resting condition.

21. A theft-protection element according to claim 20, characterized in that the release means (10) is so designed that the said slide is provided with a locking peg (15) that is arranged to interact with a hole (18) in a leaf spring (10) in the locked condition (3b) of the needle (3), and in that the said leaf spring (10) is arranged to be released from the said locking peg (15) under the influence of a magnet (13) through the leaf spring being displaced outside of the locking peg (15).

22. A theft-protection element according to claim 12, characterized in that the theft-protection element (1) comprises an electronic element (17) arranged to interact with a detector in association with the exit from a sales location for the item, and in that the said detector is arranged to raise an alarm when the theft-protection element passes through the said exit.
